(19) United States
(12) Patent Application Publication
(10) Pub. No.: US 2015/0100986 A1
(43) Pub. Date: Apr. 9, 2015

(54) CONTROLLING METHOD FOR RECORDING DIGITAL TELEVISION PROGRAMS

(71) Applicant: WISTRON CORP., NEW TAIPEI CITY (TW)

(72) Inventors: Chih-An YANG, NEW TAIPEI CITY (TW); Tsung-Cheng CHIANG, NEW TAIPEI CITY (TW)

(73) Assignee: WISTRON CORP., NEW TAIPEI CITY (TW)

(21) Appl. No.: 14/267,930

(22) Filed: May 2, 2014

(30) Foreign Application Priority Data
Oct. 8, 2013 (TW) 102136348

(51) Int. Cl. H04N 21/434; H04N 21/6543; G11B 20/10; H04N 21/433; H04N 21/2362; H04N 21/472

(52) U.S. Cl. CPC H04N 21/4345; H04N 21/2362; H04N 21/47214; G11B 20/10; H04N 21/4334; H04N 21/6543
USPC 725/50

(57) ABSTRACT

A controlling method for recording digital television programs is disclosed herein. The controlling method includes steps as follows. A service information packet is received from a digital television system terminal. The service information packet is valid within a time limitation and the service information packet includes an event information table corresponding to a plurality of program episodes. When one of the program episodes is assigned to be a first recording target and a predetermined recording period exceeds the time limitation, the service information packet is demodulated to obtain an event information section of the first recording target from the event information table. When the service information packet is updated, a matching procedure is performed on the event information section of the first recording target with the updated service information packet. A matched program episode is added into a scheduled recording target list automatically.

### RELATED APPLICATIONS

This application claims priority to Taiwanese Application Serial Number 102136348, filed Oct. 8, 2013, which is herein incorporated by reference.

### FIELD OF INVENTION

The disclosure relates to a digital television. More particularly, the disclosure relates to a manner for recording a digital television program.

### BACKGROUND

Digitalization of television (TV) broadcasting is a trend all over the world. In other word, signals for TV broadcasting used to be in an analog format have been gradually transformed into a digital format. Many digital TV channels start to operate and the conventional analog channels are scheduled to be terminated, such that the development of digital TV industry is accelerating in many countries. In present applications, the signals for digital TV are transmitted along with Electronic Program Guide (EPG) provided by TV content providers (i.e., TV network operators) to digital set-top boxes owned by users or TVs integrated with built-in digital demodulators.

When users can not watch their favorite programs due to important events, users will usually set up a scheduled recording feature for recording the program they miss at the time, so as to watch the program later. The current EPG provided by the TV content providers only includes program information of a short time period in near future. Therefore, users can only set up the scheduled recording feature for one episode or a few episodes in near future. Users can not go beyond the time limitation of the EPG and can not set up the scheduled recording feature toward the program episodes in the same series for a long time to come. For example, when the user wants to watch the whole series of a target program, the user must manually set up the scheduled recording feature by multiple manipulations at different time points, and it is inconvenient to the user who wants to track the same program in series. Another conventional approach for recording the program in series is achieved by setting up the scheduled recording feature to record a specific channel at a specific time period. However, aforesaid approach may record wrong contents when the broadcasting time/channel of the target program is changed.

### SUMMARY

An aspect of the disclosure is to provide a controlling method for recording digital television programs is disclosed. The controlling method includes steps as follows. A service information packet is received from a digital television system terminal. The service information packet is valid within a time limitation and the service information packet includes an event information table corresponding to a plurality of program episodes. When one of the program episodes is assigned to be a first recording target and a predetermined recording period exceeds the time limitation, the service information packet is demodulated to obtain an event information section of the first recording target from the event information table. When the service information packet is updated, a matching procedure is performed on the event information section of the first recording target with the updated service information packet. A matched program episode is added into a scheduled recording target list automatically.

Based on aforesaid aspect, the controlling method for recording digital television programs can demodulate a service information packet automatically and search a target program of user's interests from an event information table within the service information packet. An event identification code or a program description string from the event information table is utilized to be a matching reference while searching the target program. When the service information packet is updated, a program episode with on event identification code or a program description string, which is the same as or related to the target program, is added to the scheduled recording target list automatically. Therefore, the scheduled recording feature can be applied onto future episodes even when the predetermined recording period assigned by users exceeds the valid time limitation of the service information packet. In addition, the scheduled recording feature can work properly even when a broadcasting hour of the target program is changed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a controlling method for recording digital television programs.

FIG. 2, which is a schematic diagram illustrating an electronic program guide corresponding to a present service information packet according to an embodiment of the disclosure.

FIG. 3 is a schematic diagram illustrating an electronic program guide corresponding to the updated service information packet according to an embodiment of the disclosure.

FIG. 4 is a schematic diagram illustrating the controlling method further includes steps for verifying the prescription according to an embodiment of the disclosure.

FIG. 5 is a schematic diagram illustrating the controlling method further includes steps relative to re-allocate multiple recording targets according to an embodiment of the disclosure.

FIG. 6 is a schematic diagram illustrating the controlling method further includes steps relative to a resolution configuration according to an embodiment of the disclosure.

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

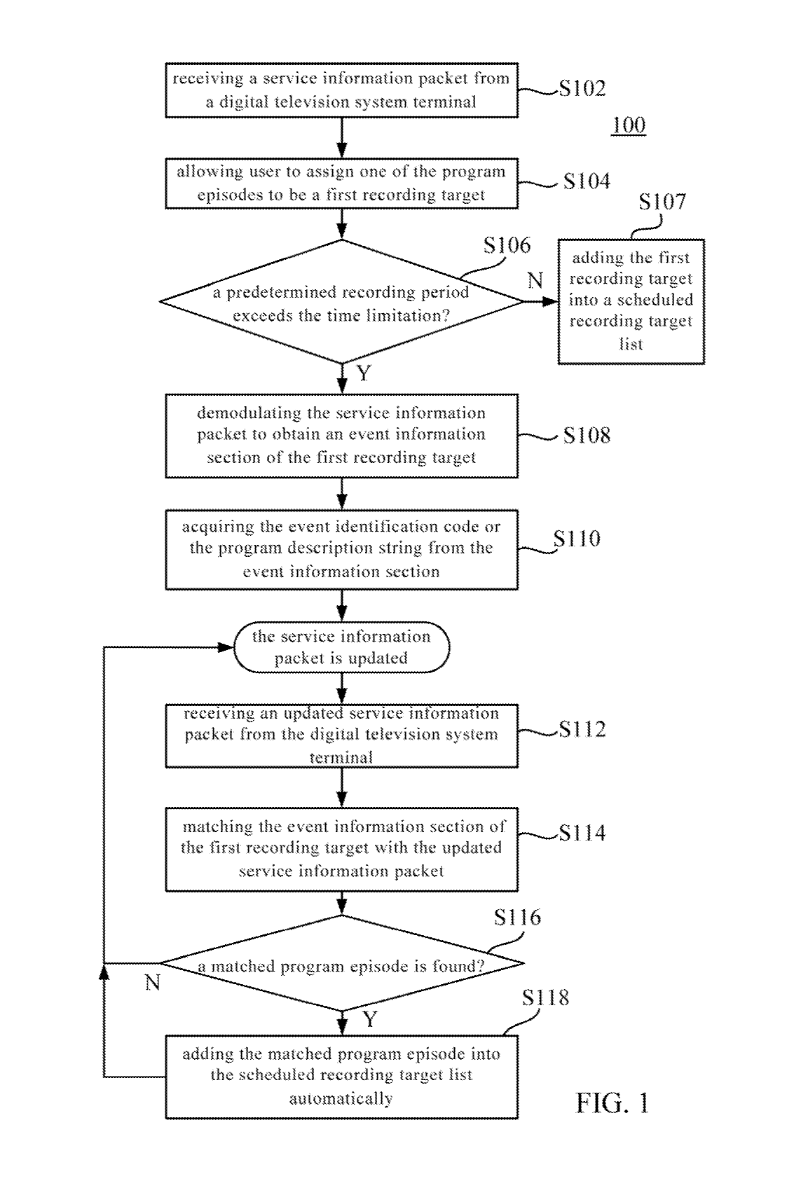

Reference is made to FIG. 1, which is a schematic diagram illustrating a controlling method 100 for recording digital television (TV) programs. The controlling method 100 is configured to record digital TV programs of user's interests corresponding to a schedule set up according to manipulations from users. In practices, the controlling method 100 is suitable to be implemented on a set-top box, a TV integrated with digital TV demodulating function or any equivalent multimedia playing device capable of receiving/playing/recording digital TV programs.

As shown in FIG. 1, the controlling method 100 for recording performs step S102 for receiving a service information packet from a digital television system terminal. In some embodiments, the service information packet is a Digital Video Broadcasting Service Information (DVB-SI) packet. The DVB-SI packet can be demodulated by the set-top box, the TV or the multimedia playing device. The information demodulated from the DVB-SI packet includes an electronic program guide (EPG) as a reference material for users. Contents of the electronic program guide include titles, brief introductions, broadcasting hours, program backgrounds and related data (e.g., castings of programs) of the programs at the time, and the electronic program guide also includes related data or trailers of following programs.

Within the contents of ordinary DVB-SI packets, the electronic program guide contains only data in a short period of dine of near future, for example, a list of programs within the next day, the next week, or the next month. The electronic program guide coverage of future time period is decided by individual system operator. In accordance to some factors, such as a transmission rate and a program arrangement, the DVB-SI packet from the digital television system terminal usually provide program information (e.g., the electronic program guide) within one week or two weeks. In other words, the DVB-SI packet is usually valid within a certain time limitation.

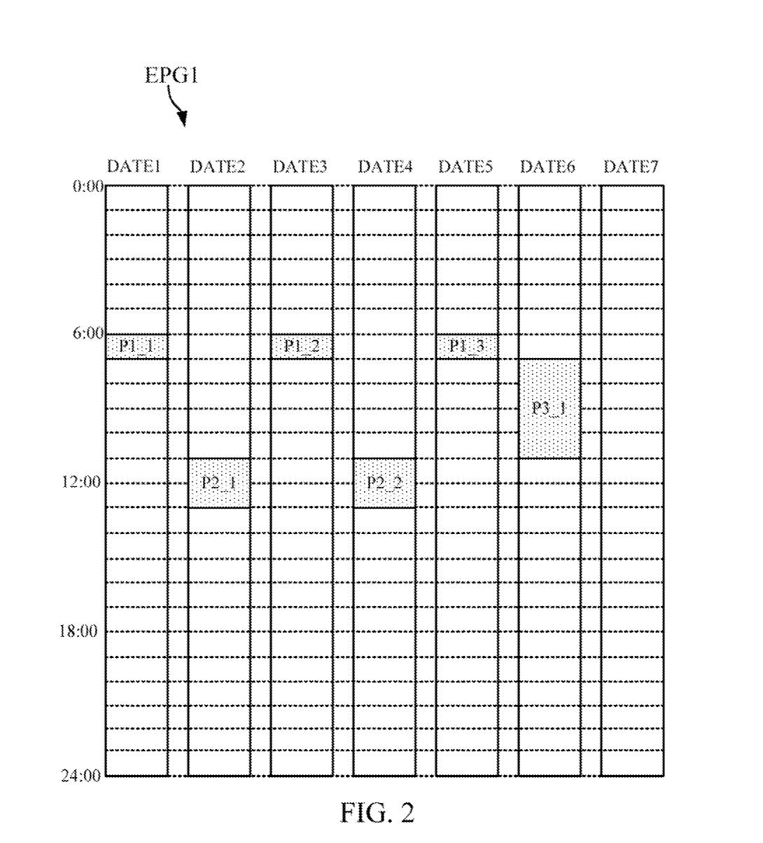

Reference is also made to FIG. 2, which is a schematic diagram illustrating an electronic program guide EPG1 corresponding to a present service information packet according to an embodiment of the disclosure. As shown in FIG. 2, the electronic program guide EPG1 includes information within one week (during DATE1˜DATE7). In order to keep the brevity of illustrations, FIG. 2 only shows the programs on one single channel. In practices, the electronic program guide EPG1 of the DVB-SI packet shall include data of multiple channels, and is not limited to the example shown in FIG. 2.

When users can not watch their favorite programs due to important events, users will usually set up a scheduled recording feature for recording the program they miss at the time, so as to watch the program later. The current electronic program guide provided by the TV content providers only includes program information of a short time period in near future. Therefore, users can only set up the scheduled recording feature for one episode or a few episodes in near future. Users can not go beyond the time limitation of the EPG and can not set up the scheduled recording feature toward the program episodes in the same series for a long time to come. For example, when the user wants to watch the whole series of a target program, the user must manually set up the scheduled recording feature by multiple manipulations at different time points, and it is inconvenient to the user who wants to track the same program in series.

In practical applications, the contents of the service information packet include many data structural table, such as Network Information Table (NIT), Service Description Table (SDT), Event Information Table (EIT), Time and Date Table (TDT) and so on.

Among these tables, the Event Information Table is utilized to provide program details and a program list of each service (e.g., each TV channel) in an event-based format. Each of the Event information Table corresponds to multiple programs provided, by the TV content providers (i.e., TV network operators), and the Event Information Table can provide basic information about each program. Most information of the electronic program guide EPG1 is stored within the Event Information Table.

When the user activate the scheduled recording function, a recording target can be selected by the user from the program episodes shown in the electronic program guide EPG1 corresponding to the present service information packet. As shown in FIG. 1, the controlling method 100 for recording performs step S104 for allowing the user to assign one of the program episodes to be a first recording target.

Then, the controlling method 100 for recording performs step S106 for determining if a predetermined recording period assigned by the user exceeds the time limitation (e.g., the time period from DATE1 to DATE7) of the present service information packet. For example, if user selects to record one singular program episode P1_1 of a program on the date DATE1, the controlling method 100 for recording performs step S107 for simply adding the first recording target (i.e., the program episode P1_1) into a scheduled recording target list so as to achieve the scheduled recording task assigned by the user, because the program episode P1_1 is existed within the time limitation of the present service information packet corresponding to the electronic program guide EPG1.

In the embodiment shown in FIG. 2, the program episodes P1_1, P1_2 and P1_3 are series of the same program, and the program episodes P2_1 and P2_2 are series of another program. In practices, each TV program series includes multiple program episodes which are broadcasted regularly and periodically on different dates.

If the user wants to record the program episodes P1_1, P1_2, P1_3 and the following program episodes in the same series in the future, the user can assign a specific predetermined recording period for the program episodes P1_1, P1_2, P1_3 and the following program episodes in the same series. In an embodiment, if the user wants to record the program in the same series for one month, three month or one year, aforesaid predetermined recording period is an assigned time length, such as one month, three month or one year. In another embodiment, if the user wants to record the next 10 program episodes, the next 20 program episodes, the next season (e.g., each season may includes 8 program episodes or more), the next two seasons or the whole series of the program, aforesaid predetermined recording period corresponds to a specific amount of program episodes, a specific amount of seasons or whole series of the program episodes.

When the user selects the program episodes P1_1, P1_2, P1_3 and the following program episodes in the same series as the first recording target (similarly, the first recording target can be the program episodes P2_1, P2_2 and the following program episodes in the same series, or the first recording target can be the program episode P3_1 and the followings other cases), the predetermined according period assigned by the user exceeds the time limitation of the present service information packet (i.e., the dates DATE1 to DATE7 of the electronic program guide EPG1). In this case, the step S106 determines that the predetermined recording period exceeds the time limitation, and the controlling method 100 performs step S108 for demodulating the service information packet, so as to obtain an event information section (EIS) of the first recording target from the event information table (EIT) in the service information packet. In the event information table (EIT), each of the program episodes has an event information section on their own. Each event information section records detail information of the program episode, such as an event identification code (event ID), a program description string, a start time, a duration and other related parameters.

For example, the event information section of the program episode P1_1 includes the event identification code (e.g., 5x01), the program description string (e.g., Conan Talk Show 3^{rd} Season 7^{th} Episode), the start time (e.g., 7:00 o'clock in the morning on the date DATE1 in the embodiment shown in FIG. 2) and the duration (e.g., one hour in the embodiment shown in FIG. 2); the event information section of the program episode P1_2 includes the event identification code (e.g., 5x01), the program description string (e.g., Conan Talk Show 3^{rd} Season 8^{th} Episode), the start time (e.g., 7:00 o'clock in the morning on the date DATE3 in the embodiment shown in FIG. 2) and the duration (e.g., one hour in the embodiment shown in FIG. 2); the event information section of the program episode P1_3 includes the event identification code (e.g., 5x01), the program description string (e.g., Conan Talk Show 3^{rd} Season 9^{th} Episode), the start time (e.g., 7:00 o'clock in the morning on the date DATE5 in the embodiment shown in FIG. 2) and the duration (e.g., one hour in the embodiment shown in FIG. 2); and so on. Similar information can be obtained from the event information sections related to the program episodes P2_1, P2_2 and P3_1.

It is noticed that, the program episodes within the same series usually have the same event identification code, such as the program episodes P1_1, P1_2 and P1_3 have the same event identification code in this embodiment. In addition, the program episodes in the same series usually have program description strings, which are identical or at least similar (e.g., including the same key string). For example, the program description strings of the program episodes P1_1, P1_2 and P1_3 all include the same key string “Conan Talk Show”.

Afterward, the controlling method 100 performs step S110 for acquiring the event identification code or the program description string from the event information section corresponding to the first recording target. In step S110, the controlling method 100 further performs for registering the event identification code or the program description string obtained from the event information section corresponding to the first recording target.

Besides steps S108 and S110, the controlling method 100 further performs a step (not shown in FIG. 1) for adding the program episodes of the first recording target within the range of the electronic program guide EPG1 into the scheduled recording target list, so as to record program episodes of the first recording target within the range of the electronic program guide EPG1. However, other program episodes in the same series of the first, recording target outside the range of the electronic program guide EPG1 are set up and added by the following steps.

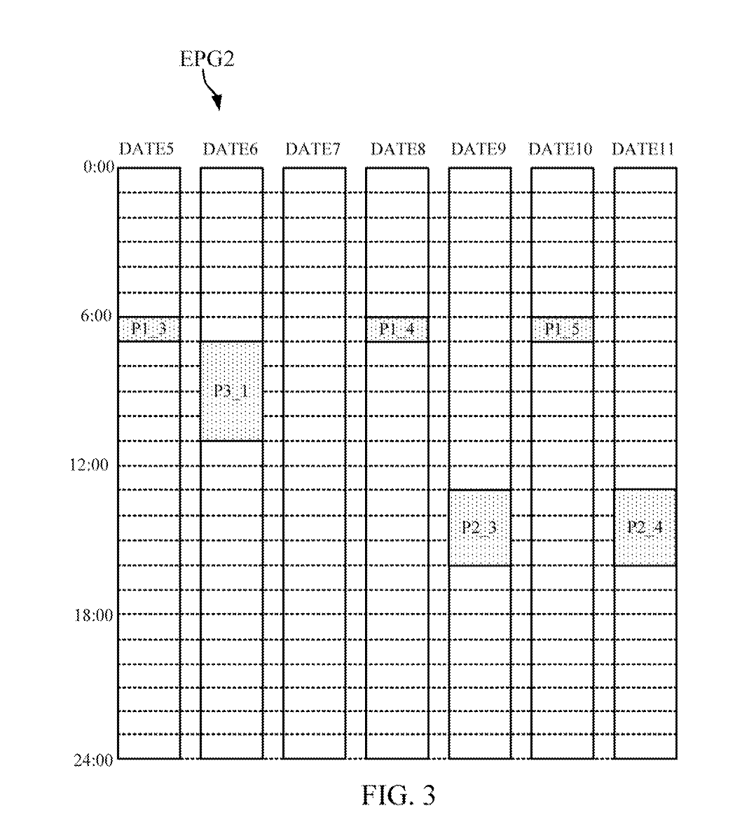

After a specific time (e.g., four days after), the digital content providers (i.e., the digital television system terminal) may perform a periodic update to the service information packet. In practical applications, the updating period of the service information packet is decided by individual digital content providers, and is not limited to every four days in aforesaid example. At the time the controlling method 100 performs step S112 for receiving an updated service information packet from the digital television system terminal. The updated service information packet corresponds to a new electronic program guide suitable for four days after. Reference is made to FIG. 3, which is a schematic diagram illustrating an electronic program guide EPG2 corresponding to the updated service information packet according to an embodiment of the disclosure.

After the service information packet is updated, the controlling method 100 performs step S114 for matching the event information section of the first recording target (e.g., aforesaid event identification code or program description string registered corresponding to the first recording target) with the updated service information packet. In the embodiment, step S114 can be triggered automatically every time when the service information packet is updated, and the disclosure is not limited thereto. In another embodiment, step S114 is performed periodically, such as the matching procedure is performed every day at 12 o'clock.

Afterward, step S116 is performed for determining if a matched program episode is found within the updated service information packet. If there is no matched program episode within the updated service information packet, the controlling method 100 keeps on monitoring and waiting for the next update (as shown in FIG. 1), or waiting for the next periodic matching procedure in another embodiment.

If a matched program episode is found, e.g., the matched program episode with the same event identification code or the same key string is found within the updated service information packet, step S118 is performed for adding the matched program episode into the scheduled recording target list automatically.

In an operational example that the first recording target is the program episodes P1_1˜P_3 and the following program episodes in the same series, after the service information packet is updated, the matching result shows that the program episodes P1_4 and P1_5 within the electronic program guide EPG2 have the same event identification code or the corresponding program description string (i.e., the same key sting). Therefore, step S118 is performed to add the program episodes P1_3 and P1_5 into the scheduled recording target list.

In another operational example that the first recording target is the program episodes P2_1˜P2_2 and the following program episodes in the same series, after the service information packet is updated, the matching result shows that the program episodes P2_3 and P2_4 within the electronic program guide EPG2 have the same event identification code or the corresponding program description string (i.e., the same key string). Therefore, step S118 is performed to add the program episodes P2_3 and P2_4 into the scheduled recording target list.

It is noticed that the event information section include the start time and the program duration of the first recording target (e.g., the program episodes P2_1˜P2_2 in this example). In the embodiment, the updated service information packet shows the start time of the following program episodes P2_3 and P2_4 in the same series is changed into 1:00 PM from 11:00 AM, and the program duration of the following program episodes P2_3 and P2_4 in the same series is changed into two hours from three hours. When the event information section of the first recording target is matched with the updated service information packet in step S116, step S118 is performed for adding the starting time and the program duration after change into the scheduled recording target list. Therefore, the controlling method 100 can correctly record the program of user's interest even when the broadcasting hours of the following episodes are changed.

In another operational example that the first recording target is the program episode P3_1 and the following program episodes in the same series, after the service information packet is updated, there is no matching result with the same event identification code or the corresponding program description string from the electronic program guide EPG2 in this case, the operation of record-setting is skipped.

Therefore, the controlling method 100 enables the scheduled recording function outside the range of the original electronic program guide EPG1, such that the user can assign to record the program episodes in the same series for one month, one year, one season, multiple seasons or even the whole series, beyond the time limitation of the present service information packet.

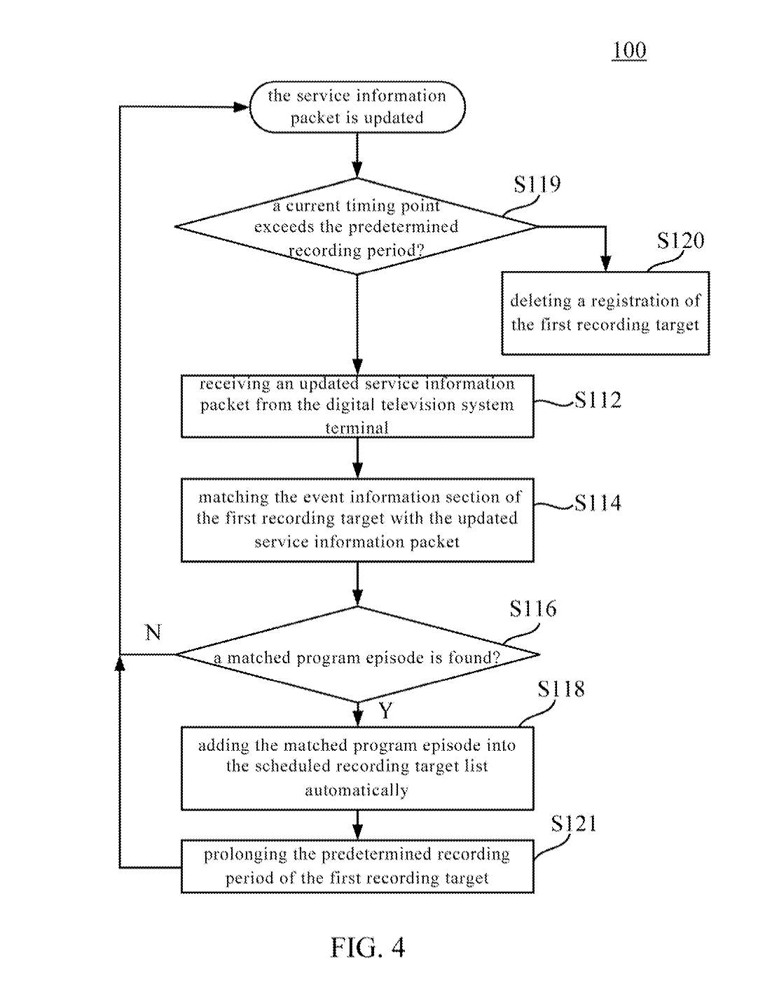

In addition, many registrations of scheduled recording target will exist in the database after the user activates the scheduled recording function from time to time. The controlling method 100 for recording, in the disclosure further includes steps for verifying the prescription of the recording targets. Reference is also made to FIG. 4, which is a schematic diagram illustrating the controlling method 100 further includes steps S119˜S121 for verifying the prescription according to an embodiment of the disclosure.

As shown in FIG. 4, when step S110 of the controlling method 100 is complete (in other words, the first recording target is registered), the controlling method 100 performs step S119 every time when the service information packet is updated, for determining if a current timing point exceeds the predetermined recording period of the first recording target. If step S119 detects that the current timing point does not exceed the predetermined recording period, the controlling method 100 continues to perform steps S112 to S116. If step S106 detects that there is no matched program episode in the service information packet, the controlling method 100 keeps on waiting for the next update. If step S106 detects that the program episode matching, the first recording target exists, step S121 is further performed for prolonging the predetermined recording period of the first recording target.

If step S119 detects that the predetermined recording period expires, it means that the schedule recording is complete or it has been a long time without a matched program episode found within the updated service information packet (the program episodes of the target series can be suspended or terminated), and step S120 is performed for deleting a registration of the first recording target, so as to avoid unnecessary computations and judgments.

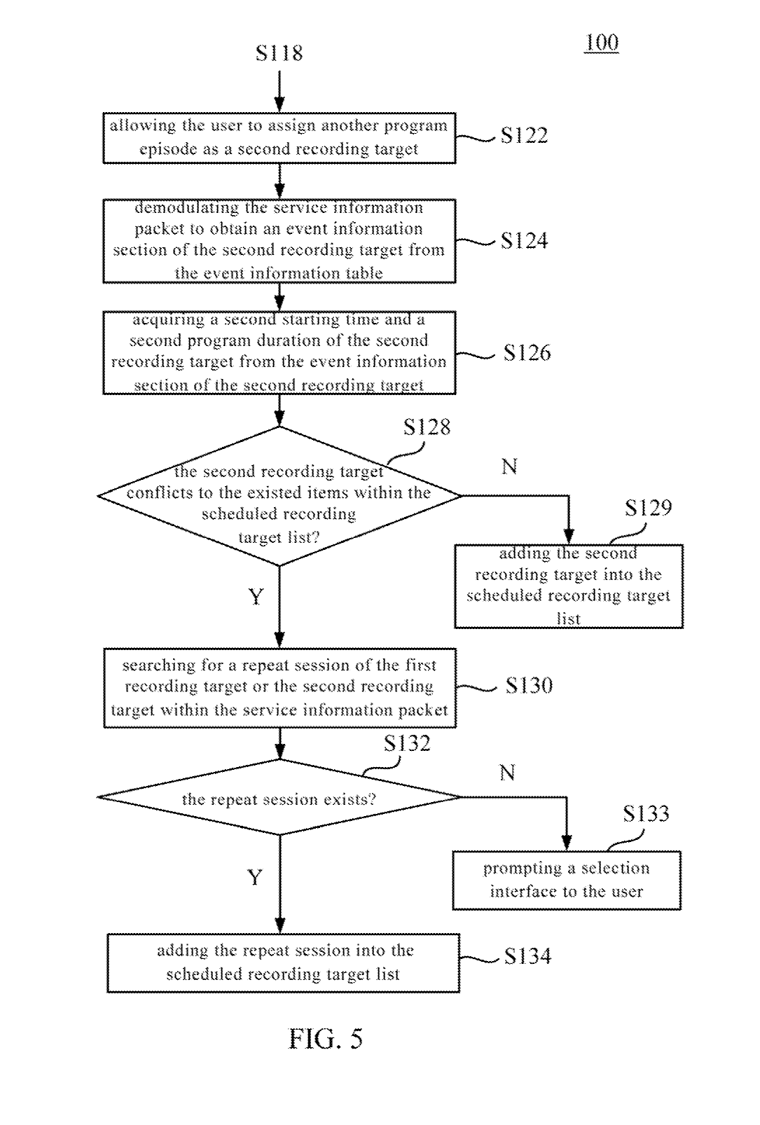

Reference is also made to FIG. 5, which is a schematic diagram illustrating the controlling method 100 further includes steps S122˜S134 relative to real locate multiple recording targets according to an embodiment of the disclosure.

When the controlling method 100 complete step S118 in FIG. 1, the first recording target and the following program episodes relative to the first recording target are added into the scheduled recording target list. For brevity reason, both of them are referred as the first recording target in the following paragraphs. In other words, the first recording target mentioned below means the first recording target itself assigned by the user and the following program episodes relative to the first recording target. After step S118, the controlling method 100 shown in FIG. 5 further includes step S122 to step S134.

Step S122 is performed for allowing the user to assign another program episode as a second recording target.

When another one of the program episodes is assigned to be the second recording target, the controlling method 100 performs step S124 for demodulating the service information packet to obtain an event information section of the second recording target from the event information table. Step S126 is performed for acquiring a second starting time and a second program duration of the second recording target from the event information section of the second recording target. The details of these steps are disclosed in aforesaid embodiments and not repeated here.

Afterward, the controlling method 100 performs step S128 for determining if the second starting time and the second program duration of the second recording target conflicts to the existed items (which means the first recording target or the matched program episode thereof) within the scheduled recording target list.

If there is no confliction between broadcasting hours of the first recording target and the second recording target, step S129 is performed for adding the second recording target into the scheduled recording target list. Furthermore, the automatic recording setting procedure shown in FIG. 1 can be applied on the second recording target again, so as to record the second recording target and the corresponding program episodes thereof.

If a confliction occurs between broadcasting hours of the first recording target and the second recording target, step S130 is performed to search for a repeat session of the first recording target or the second recording target within the service information packet according to the event information section of the first recording target or the event information section of the second recording target. In the embodiment, the confliction occurs when at least a part of broadcasting hours (acknowledged from the start time and the program duration of the second recording target) of the second recording target is overlapped with broadcasting hours (acknowledged from the start time and the program duration of the first recording target) of the first recording target or the matched program episode thereof.

Step S132 is performed to determine if one of the first recording target or the second recording target is provided with the repeat session or not. If none of the first recording target or the second recording target is provided with any repeat session, the controlling method performs step S133 to prompt a selection interface to the user. The selection interface is configured for selecting between the first recording target and the second recording target.

If one of the first recording target or the second recording target is provided with the repeat session, step S134 is performed for adding the repeat session of the first recording target or the second recording target into the scheduled recording target list. At the same time, the other one can remain its original session in the scheduled recording target list.

Therefore, when there is a conflict between the broadcasting hours of different recording targets, the controlling method 100 can search and determine at optimal allocation for recording. The optimal allocation is configured to separate the recording targets to two broadcasting hours by utilizing the repeat session, so as to achieve the function of recording two series of programs.

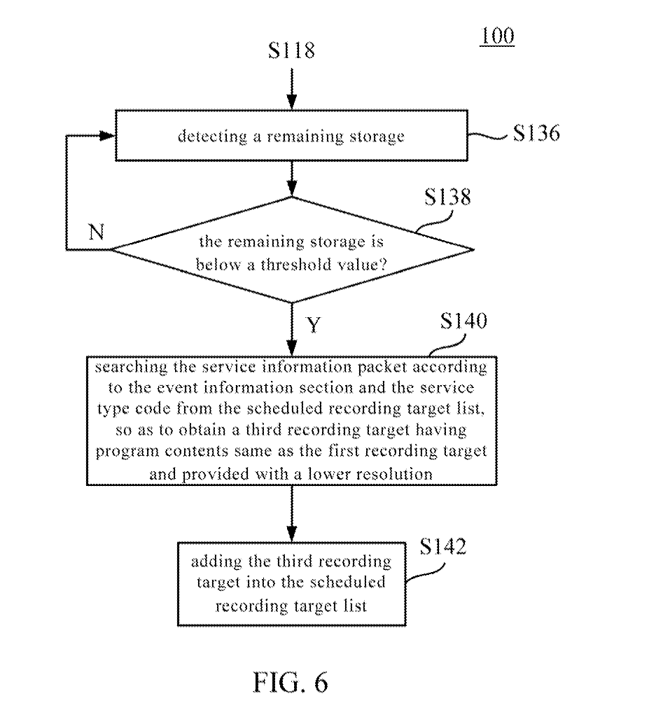

In addition, contents of the service information packet are not limited to the Event Information Table (EIT) in aforesaid embodiments. The service information packet may also include a Service Description Table (SDT). The Service Description Table includes service type codes corresponding to each of the channels. The service type code records a resolution configuration of each of the program episodes. For example, a program episode is broadcasted at a standard definition (SD) resolution on a SD channel; the program episode with the same program contents is broadcasted at a high definition (HD) resolution on a HD channel; and, the program episode with the same program contents is broadcasted at a full high definition (FHD) resolution on a FHD channel. Reference is made to FIG. 6, which is a schematic diagram illustrating the controlling method 100 further includes steps S136˜S142 relative to a resolution configuration according to an embodiment of the disclosure.

When the controlling method 100 complete step S118 in FIG. 1, the first recording target and the following program episodes relative to the first recording target are added into the scheduled recording target list. For brevity reason, both of them are referred as the first recording target in the following paragraphs. In other words, the first recording target mentioned below means the first recording target itself assigned by the user and the following program episodes relative to the first recording target. After step S118, the controlling method 100 shown in FIG. 6 further includes step S136 to step S142.

As shown in FIG. 6, the controlling method 100 performs step S136 for detecting a remaining storage on a set-top box, a television or a multimedia playing device.

Step S138 is performed for determining if the remaining storage is below a threshold value.

If the remaining storage is not below the threshold value, the controlling method returns to step S136 for monitoring the remaining storage.

If the remaining storage is below a threshold value (e.g., the remaining storage is less than 10% of the total storage), step S140 is performed for searching the service information packet according to the event information section (including the event identification code and the program description string) and the service type code of the first recording target from the scheduled recording target list, so as to obtain another program episode, which has program contents same as the first recording target and is provided with a lower resolution. In aforesaid searching procedure, the event information section is utilized to find out the program episode with the same program contents, and the service type code is utilized to judge the resolution of the program episode. According to cross-comparison according to the event information section and the service type code, the controlling method is enabled to search a third recording target having program contents same as the first recording target and provided with a lower resolution.

Afterward, step S142 is performed for adding the third recording target into the scheduled recording target list, and replacing the first recording target with a higher resolution.

Therefore, the following scheduled recording can store more program episode within the remaining storage. It is better to record the program episodes with a lower resolution, rather than not recording at all because the storage is full.

Based on embodiments, the controlling method for recording digital television programs can demodulate a service information packet automatically and search a target program of user's interests from an event information table within the service information packet. An event identification code or a program description string from the event information table is utilized to be a matching reference while searching the target program. When the service information packet is updated, a program episode with an event identification code or a program description string, which is the same as or related to the target program, is added to the scheduled recording target list automatically. Therefore, the scheduled recording feature can be applied onto future episodes even when the predetermined recording period assigned by users exceeds the valid time limitation of the service information packet. In addition, the scheduled recording feature can work properly even when a broadcasting hour of the target program is changed.

It will be understood that, although the terms “first,” “second,” etc., may be used herein to describe various elements, these elements should not be limited by these terms. These terms are used to distinguish one element from another. For example, first element could be termed a second element, and, similarly, a second element could be termed a first element, without departing from the scope of the embodiments. As used herein, the term “and/or” includes any and all combinations of one or more of the associated listed items.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A controlling method for recording digital television programs, comprising:
receiving a service information packet from a digit television system terminal, the service information packet being valid within a time limitation and the service information packet comprising an event information table corresponding to a plurality of program episodes;
when one of the program episodes is assigned to be a first recording target and a predetermined recording period exceeds the time limitation, demodulating the service information packet to obtain an event information section of the first recording target from the event information table, and registering the event information section;
when the service information packet is updated, matching the event information section of the first recording target with the updated service information packet; and
adding a matched program episode into a scheduled recording target list automatically.

2. The controlling method of claim 1, wherein, when one of the program episodes is assigned to be the first recording target, the controlling method further comprises:
determining if a program episode matching the first recording target exists in the service information packet periodically or each time when service information packet is updated;
if the program episode matching the first recording target exists, prolonging the predetermined recording period; and
if the predetermined recording period expires, deleting a registration of the first recording target.

3. The controlling method of claim 2, wherein the predetermined recording period is an assigned time length, or the predetermined recording period corresponds to a specific amount of program episodes, a specific amount of seasons or whole series of the one of the program episodes.

4. The controlling method of claim 1, further comprising:
when another one of the program episodes is assigned to be a second recording target, demodulating the service information packet to obtain an event information section of the second recording target from the event information table;
acquiring a second starting time and a second program duration of the second recording target from the event information section of the second recording target;
determining if the second starting time and the second program duration of the second recording target conflicts to the first recording target or the matched program episode thereof existed in the scheduled recording target list;
if a confliction occurs, searching for a repeat session of the first recording target or the second recording target within the service information packet according to the event information section of the first recording target or the event information section of the second recording target; and
if one of the first recording target or the second recording target is provided with the repeat session, adding the repeat session of the first recording target or the second recording target into the scheduled recording target list.

5. The controlling, method of claim 4, wherein a first starting time and a first program duration of the first recording target or the matched program episode thereof are recorded into the scheduled recording target list, the confliction occurs when at least a part of broadcasting hours of the second recording target is overlapped with broadcasting hours of the first recording target or the matched program episode thereof.

6. The controlling method of claim 4, further comprising:
if none of the first recording target or the second recording target is provided with any repeat session, prompting a selection interface for selecting between the first recording target and the second recording target.

7. The controlling method of claim 1, wherein, after demodulating the service information packet to obtain the event information section, the controlling method comprises:
acquiring an event identification code of the first recording target from the event information section;
matching the event identification code of the first recording target with the updated service information packet; and
adding the matched program episode with the same event identification code and from the updated service information packet into the scheduled recording target list.

8. The controlling method of claim 7, wherein, when one of the program episodes is assigned to be the first recording target, the controlling method further comprises:
determining if a program episode matching the first recording target exists in the service information packet periodically or each time when service information packet is updated;
if the program episode matching the first recording target exists, prolonging the predetermined recording period; and
if the predetermined recording period expires, deleting a registration of the first recording target.

9. The controlling method of claim 8, wherein the predetermined recording period is an assigned time length, or the predetermined recording period corresponds to a specific amount of program episodes, a specific amount of seasons or whole series of the one of the program episodes.

10. The controlling method of claim 7, further comprising:
when another one of the program episodes is assigned to be a second recording target, demodulating the service information packet to obtain event information section of the second recording target from the event information table;
acquiring a second starting time and a second program duration of the second recording target from the event information section of the second recording target;
determining if the second starting time and the second program duration of the second recording target conflicts to the first recording target or the matched program episode thereof existed in the scheduled recording target list;
if a confliction occurs, searching for a repeat session of the first recording target or the second recording target within the service information packet according to the event information section of the first recording target or the event information section of the second recording target; and
if one of the first recording target or the second recording target is provided with the repeat session, adding the repeat session of the first recording target or the second recording target into the scheduled recording target list.

11. The controlling method of claim 10, wherein a first starting time and a first program duration of the first recording target or the matched program episode thereof are recorded into the scheduled recording target list, the confliction occurs when at least a part of broadcasting hours of the second recording target is overlapped with broadcasting hours of the first recording target or the matched program episode thereof.

12. The controlling method of claim 10, further comprising:
if none of the first recording target or the second recording target is provided with any repeat session, prompting a selection interface for selecting between the first recording target and the second recording target.

13. The controlling method of claim 1, wherein, after demodulating the service information packet to obtain the event information section the controlling method comprises:
acquiring a program description string of the first recording target from the event information section;
matching at least one key string from the program description string with the updated service information packet; and
adding the matched program episode with the at least one key string and from the updated service information packet into the scheduled recording target list.

14. The controlling method of claim 13, wherein, when one of the program episodes is assigned to be the first recording target, the controlling method further comprises:
determining if a program episode matching the first recording target exists in the service information packet periodically or each time when service information packet is updated;
if the program episode matching the first recording target exists, prolonging the predetermined recording period; and
if the predetermined recording period expires, deleting a registration of the first recording target.

15. The controlling method of claim 14, wherein the predetermined recording period is an assigned time length, or the predetermined recording period corresponds to a specific amount of program episodes, a specific amount of seasons or whole series of the one of the program episodes.

16. The controlling method of claim 13, further comprising:
when another one of the program episodes is assigned to be a second recording target, demodulating the service information packet to obtain an event information section of the second recording target from the event information table;
acquiring a second starting time and a second program duration of the second recording target from the event information section of the second recording target;
determining if the second starting time and the second program duration of the second recording target conflicts to the first recording target or the matched program episode thereof existed in the scheduled recording target list;
if a confliction occurs, searching for a repeat session of the first recording target or the second recording target within the service information packet according to the event information section of the first recording target or the event information section of the second recording target; and
if one of the first recording target or the second recording target is provided with the repeat session, adding the repeat session of the first recording target or the second recording target into the scheduled recording target list.

17. The controlling method of claim 16, wherein a first starting time and a first program duration of the first recording target or the matched program episode thereof are recorded into the scheduled recording target list, the confliction occurs when at least a part of broadcasting hours of the second recording target is overlapped with broadcasting hours of the first recording target or the matched program episode thereof.

18. The controlling method of claim 16, further comprising:
if none of the first recording, target or the second recording target is provided with any repeat session, prompting a selection interface for selecting between the first recording target and the second recording target.

19. The controlling method of claim 1, wherein the event information section comprises a first starting time and a first program duration of the first recording target, the controlling method further comprises:
if the first starting time and the first program duration are changed in the updated service information packet, when the event information section of the first recording target is matched with the updated service information packet, adding the first starting time and the first program duration after change into the scheduled recording target list.

20. The controlling method of claim 1, wherein the service information packet further comprises a service type code, the service type code records a resolution configuration of each of the program episodes, the controlling method further comprises:
detecting a remaining storage;
if the remaining storage is below a threshold value and the first recording target is provided with a first resolution, searching the service information packet according to the event information section and the service type code of the first recording target from the scheduled recording target list, so as to obtain a third recording target having program contents same as the first recording target and provided with a second resolution, which is lower than the first resolution; and
adding the third recording target into the scheduled recording target list.
